(19) United States
(12) Patent Application Publication
(10) Pub. No.: US 2013/0166455 A1
(43) Pub. Date: Jun. 27, 2013

(54) CREATING AND USING DIGITAL CURRENCY

(71) Applicant: Douglas Feigelson, Cincinnati, OH (US)

(72) Inventor: Douglas Feigelson, Cincinnati, OH (US)

(21) Appl. No.: 13/336,779

(22) Filed: Dec. 23, 2011

(51) Int. Cl. G06Q 40/00; H04L 9/14

(52) U.S. Cl. 705/64; 705/41

(57) ABSTRACT

Among other things, a physical device carries value and can be physically delivered in a transaction. The physical device includes a representation of the value carried by the physical device. The representation is usable to transfer the value from the physical device to a digital domain. A security feature can change from a state indicating that the value carried by the physical device has not been compromised to a state indicating that the value carried by the physical device may have been compromised. The change in state is detectable, the representation of the value carried by the physical device being inaccessible except in a manner that causes the security feature to change state.

### BACKGROUND

This description relates to creating and using digital currency.

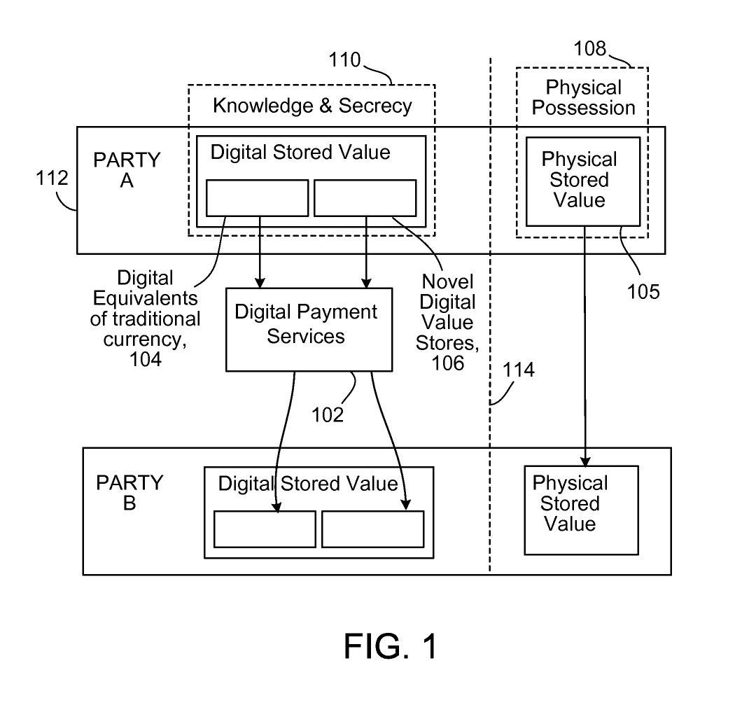

As shown in FIG. 1, computers' rapidly expanding role as a medium for commercial transactions has led to a wave of technologies 102 which aim to make digital payments possible and easy. Many of these technologies facilitate digital payments by creating a digital analog 104 of traditional currencies such as the U.S. Dollar. Other digital payment software allows for the creation and usage of entirely new digital stores-of-value 106, often known as “ecurrencies”.

Just as physical possession 108 amounts to ownership of physical stores-of-value 105 and delivery of physical stores-of-value amounts to delivery of the value in traditional transactions, knowledge of and maintenance of secrecy 110 of specific digital information amounts to ownership of stores-of-value used in digital payments. Such information could be, among other things, a cryptographic key, a unique digital token issued by a central network entity, or a password used to access a digital account. However, unlike objects of the physical world, instances of digital information may be duplicated trivially, obligating the possessor 112 of a digital store-of-value to maintain the secrecy of the information if she wishes to continue to control its value.

### SUMMARY

In general, in an aspect, a physical device carries value and can be physically delivered in a transaction. The physical device includes a representation of the value carried by the physical device. The representation is usable to transfer the value from the physical device to a digital domain. A security feature can change from a state indicating that the value carried by the physical device has not been compromised to a state indicating that the value carried by the physical device may have been compromised. The change in state is detectable, the representation of the value carried by the physical device being inaccessible except in a manner that causes the security feature to change state.

Implementations may include one or more of the following features. The physical device includes a portable device. The representation of the value is expressed in a human readable form. The human readable form includes printed characters. The representation of value is expressed in a machine readable form. The machine readable form includes a one-dimensional or two-dimensional bar or mark code. The code includes a QR code. The representation of value includes a secret. The representation of value includes a private key of a public key and private key pair. The public key (a) can be provided by a paid party to a paying party in connection with a transaction and (b) can form the basis of an address in a digital currency network to which the paying party can assign units of value for use by the paid party. The representation of value includes fifty-one ASCII encoded characters representing a base encoding of a private key part of a key pair associated with a Bitcoin-type network. The secrecy of the secret is preserved in the transaction. An anti-counterfeiting feature is provided, such as an anti-counterfeiting hologram. The apparatus of claim including a visible and human readable representation of a public key associated with the representation of value. The representation of value is cryptographically protected. The digital domain includes an online digital currency network. The digital currency network includes Bitcoin™. The security feature includes a visible element of the physical device. The security feature includes an element that visually obscures the representation of value. The security feature includes a packaging element of the physical device. The security feature includes a holographic foil. The change of state indicating that the value has been compromised includes a visible tampering.

In general, in an aspect, a physical device is produced that carries value and can be physically delivered in a transaction by imparting to the physical device a representation of value that is usable to transfer the value from the physical device to a digital domain. A security feature is imparted to the physical device that can change from a state indicating that the value carried by the physical device has not been compromised to a state indicating that the value carried by the physical device may have been compromised. The change in state is detectable. The representation of the value imparted to the physical device is inaccessible except in a manner that causes the security feature to change state.

Implementations may include one or more of the following features. The representation of value imparted to the physical device includes a secret acquired from a source. The representation of value is acquired as a secret from a source. Imparting the representation of value includes encoding a secret and storing it on a physical medium. Imparting the representation of value includes generating a private key and public key pair and using the private key as the basis for imparting the representation of value. Imparting the representation of value to the physical device includes embedding an encoded version of the representation of value in the physical device.

In general, in an aspect, as consideration in a transaction, a physical device is transferred that includes a representation of value that can be transferred from the physical device to a digital domain. A security feature can change from a state indicating that the value carried by the physical device has not been compromised to a state indicating that the value carried by the physical device may have been compromised. The change in state is detectable. The representation of the value carried by the physical device is inaccessible except in a manner that causes the security feature to change state.

In general, in an aspect, value is transferred from a physical device to a digital domain. The physical device includes a representation of the value carried by the physical device. The representation is usable to transfer the value from the physical device to a digital domain. A security feature can change from a state indicating that the value carried by the physical device has not been compromised to a state indicating that the value carried by the physical device may have been compromised. The change in state is detectable. The representation of the value carried by the physical device is inaccessible except in a manner that causes the security feature to change state. The transferring of value includes accessing the representation of value carried by the physical device, including causing the security feature to change state.

In general, in an aspect, a party is enabled to transfer value that is represented in a physical device that can be physically delivered in a transaction, directly to an online value exchange system on which the value can be represented electronically, without requiring the value to be passed through any intermediary party.

Implementations may include one or more of the following features. The value is represented in the physical device and on the online value exchange system using a common protocol for representing value.

These and other aspects, features, and implementations, and combinations of them, can be expressed as methods, apparatus, components, systems, means or steps for performing functions, program products, and business methods, and in other ways.

Other aspects, features, and implementations will become apparent from the following description and claims.

### DESCRIPTION

FIGS. 1 through 6 are block diagrams.

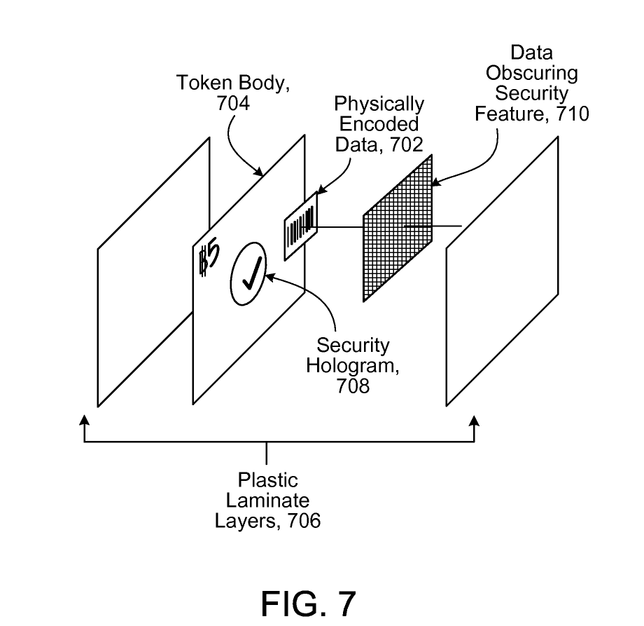

FIG. 7 is a perspective exploded view of a token.

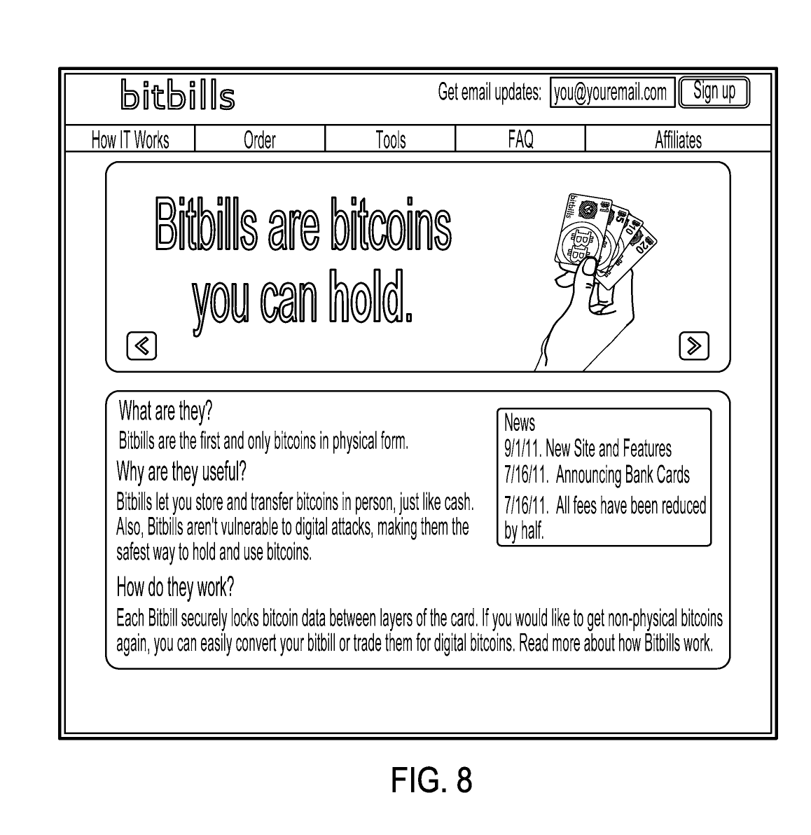

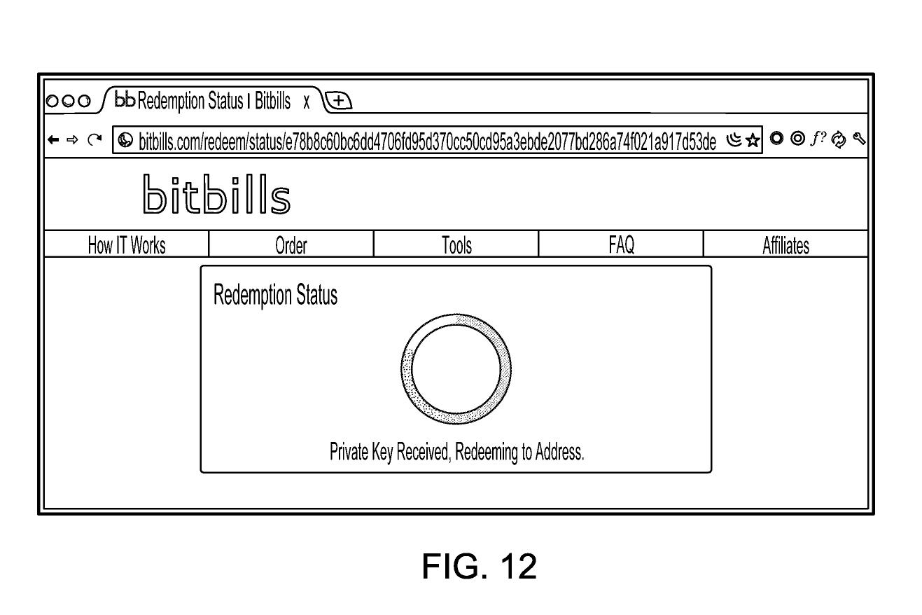

FIGS. 8 through 12 are screen shots.

An inherent difference—the secrecy—between digital and physical stores-of-value used for purposes of payment has largely confined digital stores-of-value to the digital realm and physical stores-of-value to the physical realm (the realms being separated by an imaginary boundary 114, FIG. 1). It is easy to encode digital information in a physical medium that cannot be easily physically duplicated, for example by copying a file to a USB flash drive. However, such an approach alone may be unsuitable as a physical mechanism for transferring digital stores-of-value, because the secrecy of the information contained in the medium is not necessarily preserved across a transaction in which the drive changes hands. A file on the USB flash drive may have been read and recorded by any previous physical possessor.

Because of this practical inability to exchange digital stores-of-value physically without a risk that the secrecy of the stored information has been compromised somewhere in the chain of possession, the predominant mechanism for utilizing value obtained in a digital transaction in a physical transaction or vice versa has been to exchange the store-of-value obtained in one realm for a different store-of-value better suited for the other realm. For example, to use value obtained in a digital transaction in a physical transaction (for example, to buy a meal at a restaurant), a user of the Paypal® digital payment service would transfer a balance of currency held in his Paypal account to his bank account and then withdraw physical bank notes from his bank.

For users who transact in both the digital and physical realms, there would be an advantage in having a payment system that functioned similarly in both digital and physical forms. If a digital store-of-value could be converted to an offline token that paralleled the digital form of the digital store-of-value, the complexity of the transitions between digital and physical transactions could be reduced. Such a token may allow users to convert their physical stores-of-value to digital form without the hassle or expense of any intermediary or third party. For example, where the user of the Paypal service must deposit paper money in a bank to transfer value to a Paypal account, a holder of such a token could transfer the value for immediate digital use with only the help of simple software.

Although tools may exist to allow direct redemption without a third party, in some redemption systems, the issuer of the token may act acting as a third party by redeeming the value on the user's behalf and sending it back to the user's Bitcoin address. Other systems may do it entirely on the user's side without such an intermediary.

In some implementations of what we describe here, a store of value in a physical token is arranged to directly replicate a digital store-of-value so that the represented value can be transferred back and forth between a digital store-of-value and a physical store-of-value. Like traditional physical stores-of-value (a U.S. banknote, for example), the token can be arranged to be hard to duplicate physically. In some implementations, the token may contain anti-counterfeiting features to make physical duplication more difficult.

However, unlike traditional physical currencies or other physical stores-of-value, the token's trade value is represented by digital information encoded (or embedded or included) in the physical token (we use the word token sometimes as an example of or interchangeably with the phrase physical store-of-value). In order to maintain the secrecy of this digital information across changes in possession or ownership, the token is sealed in such a way that accessing the digital information requires visibly altering the token, which invalidates it for further physical transactions as any receiving party may see that the valuable data has been accessed. Because the owner or possessor of the token will not want to lose the value represented by a valid token, she will take care not to alter the token except when she chooses to convert its value to digital form.

In this way, the secret digital information, knowledge of which amounts to ownership of a digital store-of-value, can be embedded in or otherwise associated with a physical token that can be used in physical transactions, for example, transactions in which the value of the digital store-of-value can be delivered physically in exchange for goods or services of comparable value. In some implementations, the physical token is arranged so that, in connection with such a physical transaction, all parties can visibly verify that the secrecy of the contained secret data has been preserved, and thus that no other party, including any previous owner (aside from the manufacturer, who is trusted), could legitimately claim ownership of the digital store-of-value in the token. Users of such a token could make and receive payments both digitally and physically with ease and without having to worry about the conversion between different stores-of-value being cumbersome or difficult. Such physical tokens could be passed around without regard for the technical issue of maintaining data secrecy. If a user wanted to use the store-of-value again digitally, rather than physically, he can reveal the token's data (which is done in a way that visibly terminates the usability of the token for further transactions), which then can be uploaded and used for digital payments with ease. The store-of-value's transition to the digital realm is indicated by a visible change made to the token when reading the data, invalidating the token for further offline use.

Thus, the token is an example of a physical device that carries value and can be physically delivered in a transaction. The value carried by the physical device can be embodied in a representation of that value that is part of the physical device. The representation of the value is usable to transfer the value from the physical device to a digital domain. A security feature of the physical device can change from a state indicating that the value carried by the physical device has not been compromised (for example, its secrecy compromised) to a state indicating that the value carried by the physical device may have been compromised. The change of state is detectable. The representation of value carried by the physical device is not accessible except in a manner that causes the security feature to change its state.

When we use the phrase “physical device” we mean it in the broadest sense to include, for example, any physical thing of any size, configuration, material, or construction, and any combination of those characteristics that can be delivered from one party to another as part of a transaction.

We use the term “value” in its broadest possible sense to mean, for example, anything that can be used in a transaction in exchange for any possible kind of consideration.

The term “representation” is meant in its broadest sense to include, for example, any sort of physical, electronic, or digital manner of expression of what is being represented.

A “security feature” is meant in its broadest sense to include, for example, any feature that protects, screens, obscures, safeguards, secures, limits or prevents access to the thing that is subject to the security feature, for example.

When we say that, for example, the state of a feature is “detectable” we mean it in the broadest sense and to include, for example, any respect or combination of them in which the feature can be perceived, sensed, detected, comprehended, or understood by a person or a device of any kind

A representation of value is said to be “inaccessible” when in the broadest sense it cannot be, for example, uncovered, exposed, detected, appreciated, read, determined, identified, or used, among other things.

In some implementations, a physical token that stores value by containing valuable digital information and preserving its secrecy, can be made as follows.

In the example that we describe here, the process of manufacturing a token includes three main phases: acquiring the valuable secret data to be stored within the token, physically encoding the secret data and embedding the encoded data within the token, and manufacturing the token in such a way as to promote its practical use, prevent counterfeiting, and require conspicuous alteration in order to access the embedded secret data.

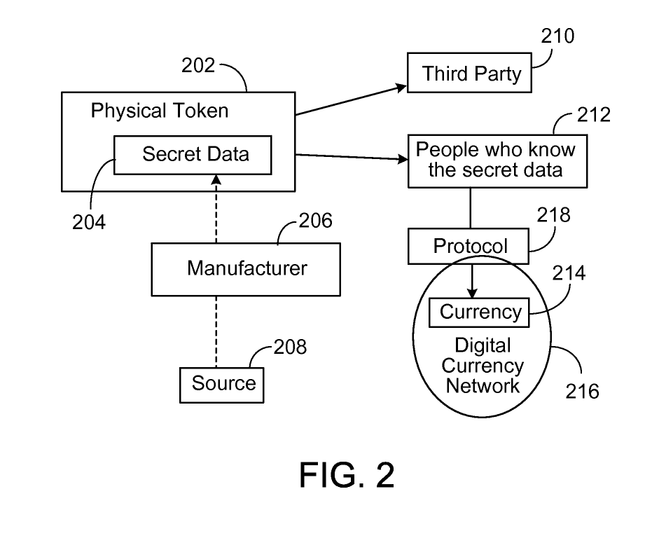

As shown in FIG. 2, a physical token 202 is to contain secret data 204 that is to be obtained by the manufacturer 206 of the token from a source 208. Such secret data may include any secret information for which knowledge of the information may at some time be deemed of value by a third party 210.

For example, the information may allow anyone who knows it 212 to take ownership of corresponding digital currency 214 on a digital currency network 216 (or other online value exchange system or other digital domain). The type, quantity, expression, and other specifics of the secret data could vary depending on the protocol 218 of the digital currency network for which the token is intended to store value. For example, if the secret data to be stored is a private key on the Bitcoin network, then the secret data may consist of 51 ASCII encoded characters representing a base 58 encoding of the private key part of a key pair. It is presumed that the digital currency network's protocol is arranged to be able to vest each owner of units of the digital currency with an instance or instances of unique secret data that may be used to assert ownership of and to engage in transactions using currency owned by the user. In this sense and in this example, ownership of units of digital currency in the network may be defined by ownership of the corresponding controlling secret data. In the example that we are describing here, it is an instance or instances of this secret data that will be obtained for containment in the token.

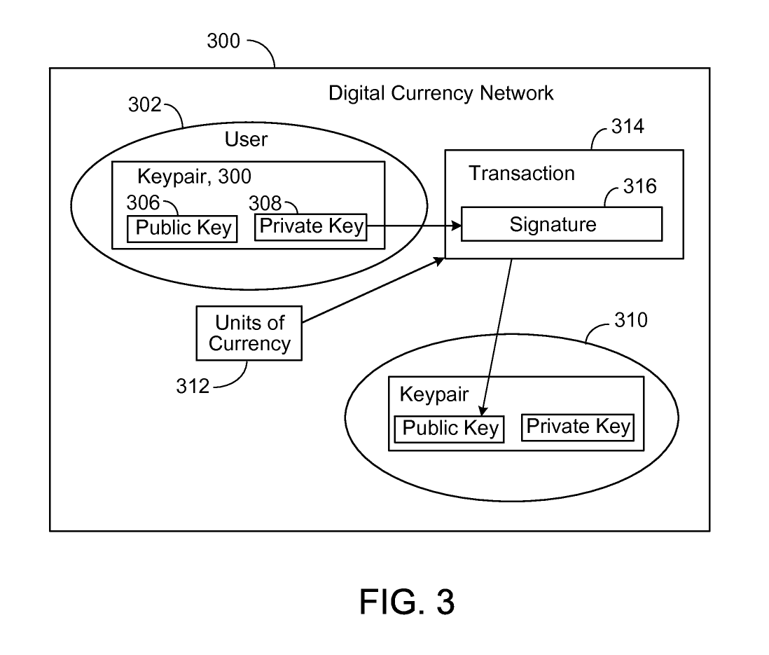

As shown in FIG. 3, in some implementations, a digital currency network 300 (or other online value exchange system or other digital domain) may utilize a public key cryptography scheme as an addressing system. In such a scenario, a user 302 of the network (we use the term “user” broadly to include, for example, a person and any software or services used by or operated on behalf of the person, among others) will receive a public key and private key cryptographic key pair 304 either by generating such a key pair in accordance with a protocol of the digital currency network or by receiving one from another node on the network.

The public key 306 part of the key pair, or some derivative of the public key such as its hash, can function, within the network, as an address (or an address can be constituted or derived from it) that a user 302 may share with another party as a first step in conducting a transaction (not shown) in which the other party is going to deliver digital currency to the user. The location that is addressed serves as an account in the record-keeping system of the network to which the other party may assign units of currency 312 for later use by the user 302. If, at a later time, the user 302 who has received the units of digital currency wishes to send that currency to another user 310, the first user 302 would then use the private key associated with the public key (from which the address was constituted or derived) to conduct a new transaction (shown in FIG. 3 as 314) transferring the units received at that address in the former transaction to the new recipient user 310 in the new transaction 314. For example, the network may require that the currency-sending user cryptographically sign the new transaction 314 (signature shown as 316) by encrypting a hash of the transaction message with the user's corresponding private key. This process can be repeated for use of the value in successive transactions in a chain from user to user. After a unit of currency has been used in several transactions, the record-keeping system of the network may juxtapose all those transactions in which the unit was transacted to show the unit's chain-of-ownership, in which each link (a transaction) includes an address and a cryptographic signature of that address generated using the private key corresponding to the address in the previous link. The present owner of the unit of currency is the possessor of the private key corresponding to the last address in this chain. In such a digital currency network based on a public key cryptography scheme, it is an instance of this private key that would be obtained for containment in a token or other physical device.

In some implementations, the digital currency network may be a peer-to-peer network of the kind proposed in a white paper published May 24, 2009, under the name Satoshi Nakamoto, commonly known as “Bitcoin”. This network utilizes a private key and public key cryptography scheme as an addressing system. Users generate key pairs on a local computer in accordance with the Eliptic Curve Digital Signature Algorithm (ECDSA). Addresses are derived from the RIPEMD-160 hash of the public key. Transaction messages on the Bitcoin network include, among others, the address of the recipient user and the cryptographic signature of the sending user. The signature is to be generated using the private key corresponding to a public key at whose derivative address the currency-sending user had previously received units of currency. In some implementations of the Bitcoin example, it is an instance of such a private key that would be obtained for inclusion in the token or other physical device.

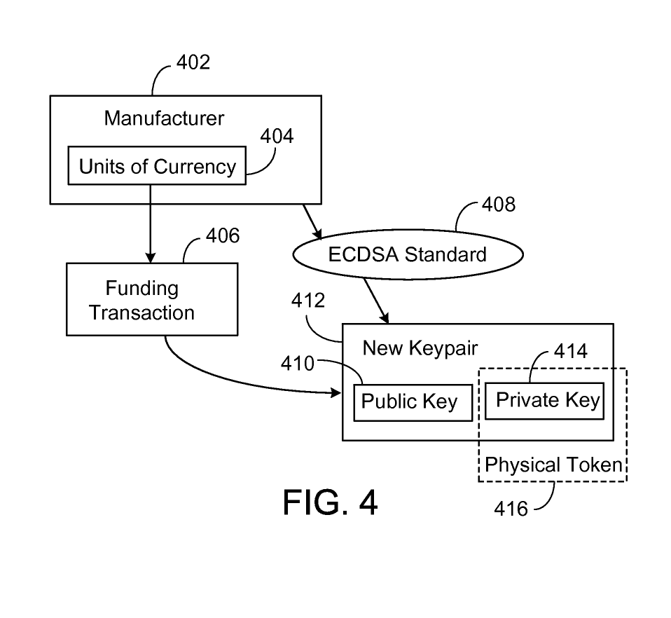

Thus, the secret data (or other representation of value) may be extracted or derived by the manufacturer of the token from data of the kind that is generated and received during the course of regular usage of any digital currency network. For example, in a public key cryptography based network as shown in FIG. 4, the needed secret data may be obtained by extracting the private key from the cryptographic key pair obtained from the network, for example??.

In implementations that use the Bitcoin network, the manufacturer 402 may use the network to generate a new key pair 412 in accordance with the ECDSA standard 408. The manufacturer may take the private key 414 of the key pair as the secret data. The secret data may, but need not, allow access to some amount of digital currency at the time of manufacture (in which case the manufacturer would send currency to the address corresponding to the newly generated key pair after generating the key pair but before manufacturing a token using that key pair). In any case, the secret data may be expressly made valuable (by such a deposit, for example) by the manufacturer or another party at a later time. For example, the manufacturer could conduct a transaction 406 on the digital currency network transferring units of digital currency 404 to an address that may only be accessed using private key data stored within a physical token 416 manufactured at a previous time.

Measures should be taken to ensure that the secret data remains unknown to some or all parties other than the manufacturer. In the case of a digital currency network, such measures may include offline key pair generation on a secure computer and destruction of any records of a private key following manufacture of a physical token.

In the example of a manufacturer obtaining as the secret data to be contained in the token a private key from the Bitcoin digital currency network, the manufacturer may begin by obtaining the source code of the reference implementation of the Bitcoin client software. The standard Bitcoin client software running on the manufacturer's computer will already include the capability to generate key pairs in compliance with the Bitcoin protocol; however the generated key pairs may not be in a suitable form for extraction, for example, of the private keys for containment in the physical token. Therefore, the manufacturer may choose to modify the source code to allow the client software to export key pairs in a suitable form. For example, the manufacturer may alter the client software to allow it to export key pairs in the form of an ASCII-encoded digital text file, containing public and private key numbers encoded in a base 58 scheme.

After obtaining the secret data, the manufacturer encodes and stores it on a physical medium to be included as part of the token. A wide variety of methods can be used for physically encoding digital information, many of which may be suitable for encoding the manufacturer's secret data. In some implementations, physical encoding involves using volatile or non-volatile flash memory chips, which can be programmed in such a way as to output the secret data at a later time. In some implementations, encoding involves storing the data magnetically on magnetic tape or a “magstripe”, which may be read using a special reader to reveal the secret data. In some implementations, the data may be encoded as alphabetic or numerical characters printed onto paper, which may be read by an unassisted human. In some implementations, the data may be encoded as small physical features etched into a substrate, to be read by optical or other means. In some implementations, the data may also be encoded as a series of glyphs printed on paper or another substrate in one or two dimensions to be read by an imaging device, for example a barcode. In such implementations, the glyphs could be generated using any of a number of standards, such as the QR Code standard originally designed by Denso Wave Inc. The manufacturer may choose one or more of these or of the numerous other encoding methods for use in containing the secret data on a physical medium for inclusion in the token. A combination of any two or more techniques can be used for physically encoding the secret data in a single token.

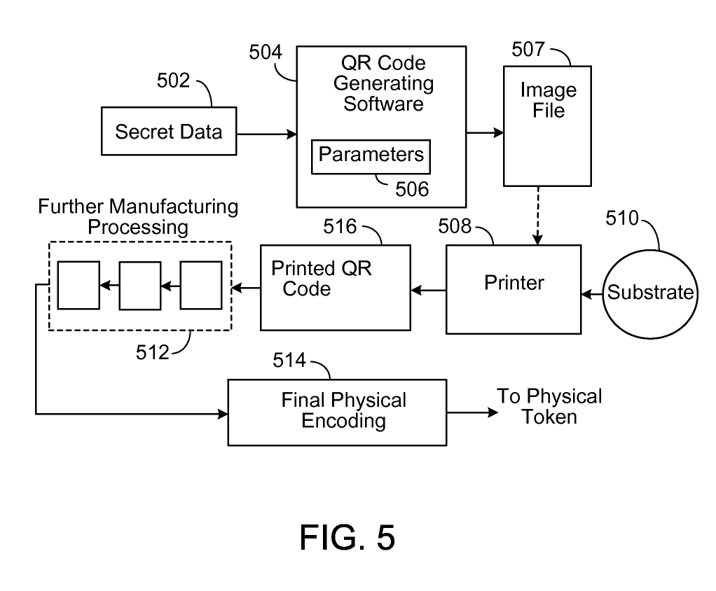

As shown in FIG. 5, in implementations in which the manufacturer chooses to encode the secret data 502 using the QR Code standard, the manufacturer may use computer software 504 that takes as an input the secret data obtained by the manufacturer and, subject to parameters 506 such as error correction level and QR code size, generates an image file 506 of a standards-compliant QR code.

The manufacturer can take many precautions to maintain the secrecy of the secret data and of all of its encoded forms. For example, the manufacturer may choose to perform the QR image file generation on offline, secured computers in a physically isolated environment. Once an image file is generated, the manufacturer may print it onto paper or another substrate 510 using any one or a combination of a wide variety of methods, including a laser or ink-based printer 508. The manufacturer may further process this printed QR code 516 in additional stages 512 in order to ensure its durability, its ability to be joined with a physical token, and its readability among other factors. Accordingly, the manufacturer may laminate or seal it with protective plastic under heat and pressure. Following any additional processing steps, the manufacturer will have the final physical encoding 514 of the secret data, ready for containment in the token.

Production of the token's body may include many manufacturing steps apart from the manufacture of the secret data's physical encoding discussed above. Depending on desired physical characteristics of the final token, the manufacturer may choose to begin production of the token from any material. For example, the material may be a plastic such as PVC, a wood, a metal a synthetic printing medium, such as the porous polymer film commonly known as “Teslin”, or an animal hide, or any combination of the two or more of those and other materials, among others.

In various implementations, the manufacturer can form, shape, mold, cut, or machine (or a combination of any two or more of them) the material into the approximate shape and size of the final token, or into a shape and size desirable for manufacturing the token or multiple tokens out of the material. The manufacturer may then proceed through a number of further processing stages to alter the appearance and/or properties of the material. The manufacturer may print, stamp, and/or affix functional or decorative elements to the material. The manufacturer may print a decorative design and/or brand onto the material, and may print onto the token the amount of value to be stored within the token to indicate the token's “denomination”.

The manufacturer may process the material in such a way as to provide security features for the final token. One class of security features that the manufacturer may add to the token is anti-counterfeiting, for example, features that make it difficult or impossible for parties other than the manufacturer to produce a token that may be misidentified as having been produced by the manufacturer. Such anti-counterfeiting features may include, but are not limited to: watermarks, micro-printing, security holograms, serial numbers, heat-sensitive or color shifting inks and dyes, finely featured designs and patterns, hidden and UV sensitive printing, and security threads and fibers, and any combination of two or more of those features and others.

In implementations in which the manufacturer chooses to affix a security hologram to the token, the hologram may be in the form of a sticker comprised of foil with adhesive backing onto which the hologram has been printed, to be applied to the token. In some implementations, the hologram may be printed onto foil that the manufacturer may hot stamp onto the token substrate. It is possible for the manufacturer to use the physically encoded data itself as part or all of the token's body, and apply one or more of the above manufacturing steps to the physically encoded data. In such implementations, there may be no need for a separate processing step to embed the physically encoded data into a token body.

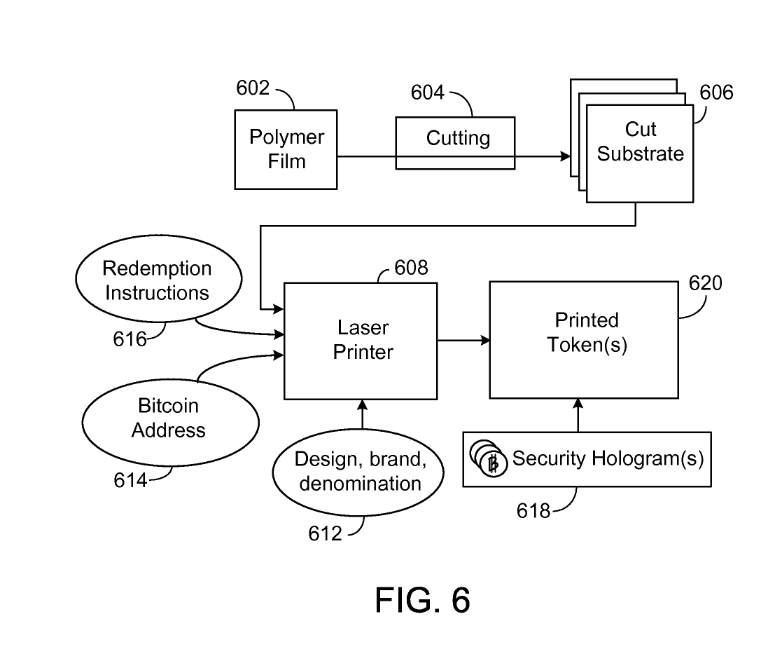

In some implementations, as illustrated in FIG. 6, the manufacturer may cut 604 a polymer film 602 to a reasonable size, for example to 8.5 by 11 inches, for producing a set quantity of tokens. The manufacturer may then use a laser printer 608 to print the design, brand, and denomination 612 of the tokens onto the cut substrate 606.

If the secret data to be stored within the token is (or is based on) a cryptographic private key, the manufacturer may choose to print the corresponding public key, or a derivative such as its RIPEMD-160 hash, onto the material so that it is visible to anyone who has possession of the token. In the case that the secret data to be embedded in the token is a private key that can be used to claim currency on the Bitcoin ecurrency network, the manufacturer may print onto the face of the material the Bitcoin address 614 that corresponds to the private key to be stored within the token. This may be useful to the user by allowing her to verify that the data in the token remains valuable by checking the balance held at the printed Bitcoin address. It may also be useful for when the user chooses to redeem her token by accessing its secret data. Similarly, instructions for redeeming the token 616 may be printed onto the token substrate.

The denomination that the manufacturer prints onto the substrate may be the number of Bitcoins that have been transacted to the Bitcoin address corresponding to the secret private key that will be embedded within the token. The manufacturer may adhere one or more secure holographic stickers or foils 618 to one or both sides of the printed token(s) 620. The hologram may be such that attempted removal or tampering causes the hologram to be destroyed irreparably.

At some point in the token's production, if the manufacturer has created a token body that is distinct from a coded element that bears the physically encoded data, as shown in FIG. 7, the manufacturer embeds the physically encoded data 702 into the token body 704. The embedding of the physically encoded data will likely comprise joining the physically encoded data to the token body in some manner.

In various implementations, the joining of the encoded data to the token body may be achieved using one or a combination of any two or more or: glue, a mechanical locking mechanism, fasteners such as screws, nails, or other hardware, welding, soldering, or by sealing the physically encoded data into the token body by attaching an element to the token body over the physically encoded data, sandwiching it inside of the token. For example, in the last case, the manufacturer may seal the physically encoded data into the token body using a lamination process that uses heat and pressure to attach layers of plastic 706 over the physically encoded data. In this case, the physically encoded data would be effectively sandwiched between the token body and the top layer of lamination plastic.

The manufacturer may choose to create the token body and the physically encoded data in such a way as to facilitate this joining process. For example, the manufacturer may cut, machine, or mold the token body in such a way as to leave a cavity or crevice where the physically encoded data may be attached. Such a consideration may be important for ensuring a uniform and aesthetically pleasing final token shape. Other such design considerations for facilitating the joining process may include the addition of a mechanism that allows mechanical locking of the encoded data and token body, accommodations for mechanical fasteners such as screw holes, or roughing of the surface texture of the token body and/or physical data encoding to promote a strong glue bond.

Before or after, or both, the time when the physical data is embedded in the token, additional security features may be added. As described earlier, the manufacturer will likely build anti-counterfeiting security features such as a security hologram 708 into the token body. These security features are aimed at preventing unauthorized parties from creating tokens that may be misidentified as having been created by the manufacturer.

In some implementations, the manufacturer will also include security features that serve another purpose: to reliably prevent the physically encoded secret data from being read without irreversibly altering the visible appearance of the token. This property is important to the token's functionality. The uniqueness of the token afforded by anti-counterfeiting measures serves to convince a token holder that the token was generated by the manufacturer, whom the holder trusts to have embedded valuable secret data into the token, rather than by a counterfeiter.

The one or more features of the token that prevent the data from being readable without visible alteration 710, allow users to trade the tokens as a store-of-value with confidence and without trust in the other trading parties. The secret data encoded within the token is likely such that if one party knows the contents of the data, the data may lose its value. For example, if the secret data is a cryptographic private key affording its owner the privilege of spending a set amount of a digital currency, then if a party knows the data the party could remit this sum of currency to a different account, thus depleting the value of the secret data for future use, and thus depleting the token's value.

Since the manufacturer includes features in the token that keep the data unreadable without visible alteration, a token-receiving party in a transaction can visibly inspect the token and confidently conclude that the token is worth its designated value. This is because the receiving user trusts the manufacturer to have originally included secret data within the token of a value corresponding to a value likely marked on the token, and also trusts that the manufacturer (the only party who knows the data until the token is altered) will not deplete the value of the token at a later date. Since the token-receiving party holds this trust in the manufacturer, and since the receiving party can inspect the token to verify that the data has not been accessed by any other party, the token-receiving party can confidently accept the token as payment in a transaction.

These additional security features may be implemented in one or more of a number of ways or combinations of them. One common method of requiring that a physical object be conspicuously altered in order to view some part of it is to cover part of the object in latex or another opaque substance which can be scratched off, such as a lottery card. For example, a token may include a plastic card with a QR code that encodes a private key on an ecurrency network, which is then covered in a thin layer of latex. Users of the token could then visibly check whether the latex layer is intact, and thus verify that the token's data has not been revealed. If the holder of such a token would like to spend the stored value digitally, he could remove the latex layer by scratching it off with a fingernail or a coin, revealing the QR code.

In some implementations, the manufacturer could include a feature that prevents the data from being readable without visible alteration by obscuring the physical encoding with some securely attached covering. Suppose the token includes a plastic card manufactured by printing onto a polymer substrate and that the physically encoded data, a separately printed and laminated QR code, is glued to the substrate prior to a lamination process that seals the physical encoding within the token. In this example, the manufacturer may wrap the laminated QR code in a foil shield prior to sealing it within the token. This foil shield would serve as a security feature, preventing the QR code from being read through the laminate by optical or other means. For example, the foil could be chosen so that it prevents the printed QR code from being read even by imaging using any radiation across the electromagnetic spectrum, including imaging by x-ray.

A useful consideration when implementing this alteration-requiring security feature is that the alteration be irreversible. This means that after the data has been accessed, it should be ensured that no party other than the manufacturer can “repair” or reconstruct the token in such a way as to convince others that the encoded data has never been accessed. If a party untrusted by the token holder were able to complete such a reconstruction, then the party could defeat the secret-guarding feature of the token and defraud a future transacting party by obtaining a token in a transaction, reading its secret data, depleting its value, reconstructing the token and then trading it to another party in exchange for some other valuable good.

To address this concern, in some implementations, the manufacturer may convolve the anti-counterfeiting and data-obscuring security features of the token. For example, although a third party may be able to replace a latex coating after removing it from a token to reveal the token's data, the manufacturer may thwart this attempt to overcome the protective feature of the token, by using the anti-counterfeiting security measure of micro-printing on top of the latex coating.

In another example, although a third party may be able to remove a layer of laminate and the foil wrapper to view the secret data and then replace the wrapper and relaminate the token, the manufacturer may prevent this by printing a security hologram into the foil wrapper which cannot be duplicated and which is destroyed in the process of viewing the secret data. In such a way, the security feature that the manufacturer includes to require visible alteration to the token for reading the data may also serve a primary or secondary anti-counterfeiting security feature.

In some implementations, although the token's features assure that accessing the data will visibly alter the token, it is also desirable for the data to be easily accessible. The alteration of the token compelled by the security feature should not damage or impair the readability or other usability of the physically encoded secret data. When a holder of the token would like to access its contents, he will need to follow some procedure to open the token and read the physical encoding. If security features hinder or thwart this process, the user will be subjected to additional time and hassle. In some implementations, the manufacturer may choose to include features that assist the user in accessing the physically encoded secret data.

For example, if the token includes a plastic card with the physically encoded element sandwiched between layers of laminate, the manufacturer may choose to demarcate a region of the card that may be cut with scissors to allow the physical encoding to fall out of the token undamaged and be easily read. In some examples, the manufacturer may place a special plastic strip between layers of the token, leaving part exposed. The user may then pull on this strip to tear open the top layer of the token, exposing the physically encoded data.

In some implementations, the manufacturer uses a secure, self-destructing adhesive hologram sticker as both the primary anti-counterfeiting security feature and also to hide the secret data. The data is encoded as a laminated QR code, which is glued to the token body and sealed in via lamination. The secure adhesive hologram is applied over top of the laminated QR code prior to lamination, subsequently preventing the QR code from being read without cutting the card open and removing the hologram sticker.

The manufacturer may choose to develop software or make available instructions for redeeming the token, which involves reading the encoded physical data and using it to transfer the value to a digital store. For example, the manufacturer may make publicly available on the internet a program which, with the aid of a computer webcam or smartphone, reads and decodes a QR code that a user may have extracted from a token. The program could then assist the user in transferring digital currency funds originally associated with the token to an account of the user's choosing.

We now turn to use cases of how someone would use the techniques that we have discussed, what they could do with the techniques, how they can pass around the value of a token, and reasons why they would want to do so.

Historically, it has been relatively difficult, time-consuming, and expensive to use funds acquired in digital systems to conduct a physical transaction for value, or to load value into a digital system that has been acquired in a physical transaction. Though many systems have been developed for conducting digital transactions, they have largely required users to transition to different, incompatible systems for expressing or holding the value in order to spend digitally acquired funds in the physical world.

For example, consider a user who has acquired funds through the “Paypal” digital payment system, perhaps by selling an item through online auction. If the user wished to engage in a transaction for value with those funds in the physical world, he could transfer those funds to a bank account, where he could subsequently withdraw them as physical currency at a bank branch, and then use the currency for the transaction.

Or, consider a person who has acquired dollar bills as a gift from a friend. If he wished to use these funds to purchase an item online, he could deposit the funds in a bank branch, then transfer the funds digitally from his bank account to a digital payments service such as Dwolla® using the Automated Clearing House facility.

In some implementations, the token described here could alleviate the hassle of these digital-physical and physical-digital currency transitions.

Suppose a large, trusted manufacturer began distributing tokens in the form of plastic wallet-sized cards that which contained the data necessary for claiming digital currency on some popular digital currency network. Imagine now a street merchant who conducts an offline transaction with a customer but instead of dollar bills receives these cards. During the transaction, the street merchant could briefly examine each card to read its denomination and ensure that it has not been previously opened or tampered with. Such an inspection is not unlike one that the street merchant likely does when obtaining dollar bills. Throughout the day, the street merchant may continue transacting with these cards, perhaps transferring some of the cards he has received to other customers as change for other transactions. Now suppose that after completing his work, the merchant wished to send some of his earnings to relatives located in Europe. The merchant could cut open a few of his higher denomination cards, each revealing a QR code which he could scan using software on his smartphone. Having received the private key associated with funds on a digital currency network, the software on his phone could indicate to the merchant that he has a certain amount of digital currency stored on his smartphone, which he may then choose to send digitally to relatives in Europe chosen from his address book. After completing this transaction, the merchant may simply throw away the visibly depleted plastic cards. In this scenario, funds that had been acquired through an entirely offline physical transaction using the techniques that we have described were able to be sent instantaneously overseas digitally, with minimal hassle and, in some implementations, without any fees.

Now suppose that one of the merchant's relatives wished to use some of these funds that they have received digitally in a physical transaction. The relative could visit the manufacturer's website online and digitally send some units of the digital currency (which we sometimes call ecurrency) to the manufacturer, who could then mail the relative physical tokens. Alternatively, the relative may visit an automated teller machine, which could instantly dispense such physical ecurrency tokens in exchange for funds digitally sent to its address by a transaction conducted on the user's smartphone. For users who routinely conduct transactions both online and offline, the physical token paired with a reliable digital currency network has a strong potential to provide the simplest and most pleasant experience by unifying the currencies used in digital and physical transactions.

A user interface for an example implementation, called BitBills™, is shown in FIGS. 8 through 11. For convenience, portions of the text of these interface images is reproduced here:

FIG. 8. Bitbills are the first and only Bitcoins in physical form. Why are they useful? Bitbills let you store and transfer Bitcoins in person, just like cash. Also, Bitbills aren't vulnerable to digital attacks, making them the safest way to hold and use Bitcoins. How do they work? Each Bitbills securely locks Bitcoin data between layers of the card. If you would like to get nonphysical Bitcoins again you can easily convert your Bitbills or trade them for digital Bitcoins. Read more about how Bitbills work.

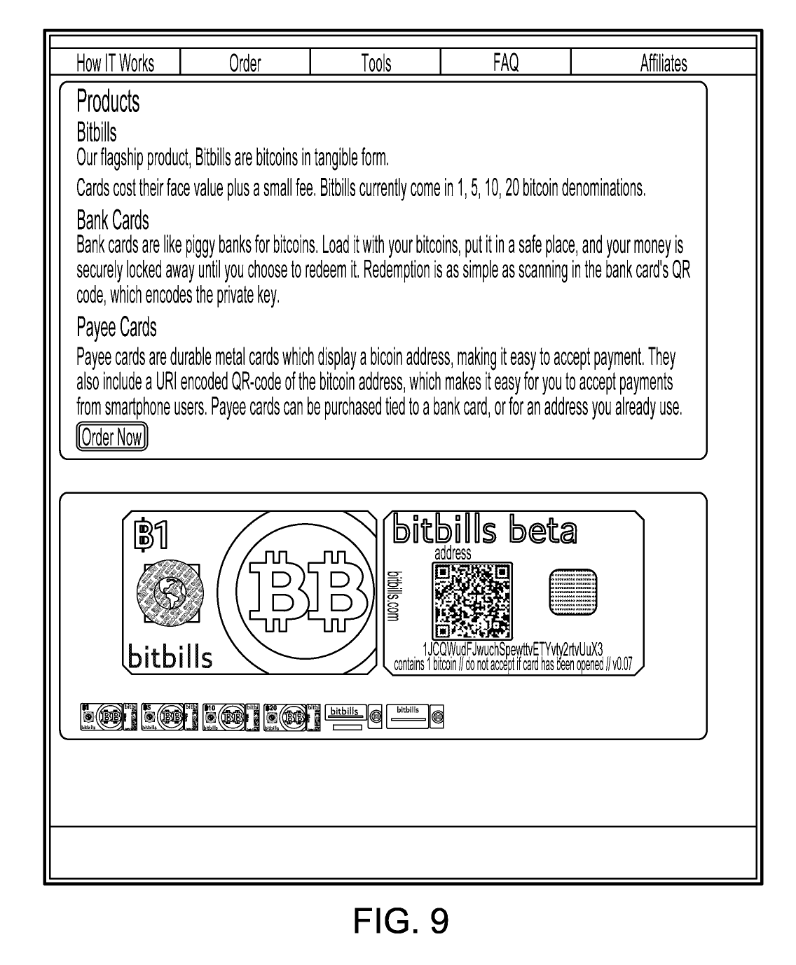

FIG. 9—Bitbills are Bitcoins in tangible form. Cards cost their face value plus a small fee. Bitbills currently come in 1, 5. 10, 20 Bitcoin denominations. Bank cards are like piggy banks for Bitcoins. Load it with your Bitcoins, put it in a safe place, and your money is securely locked away until you choose to redeem it. Redemption is as simple as scanning in the bank card's QR code, which encodes the private key. Payee cards are durable metal cards which display a Bitcoin address, making it easy to accept payment. They also include a URI encoded QR-code of the Bitcoin address, which makes it easy for you to accept payments from smartphone users. Payee cards can be purchased tied to a bank card, or for an address you already use.

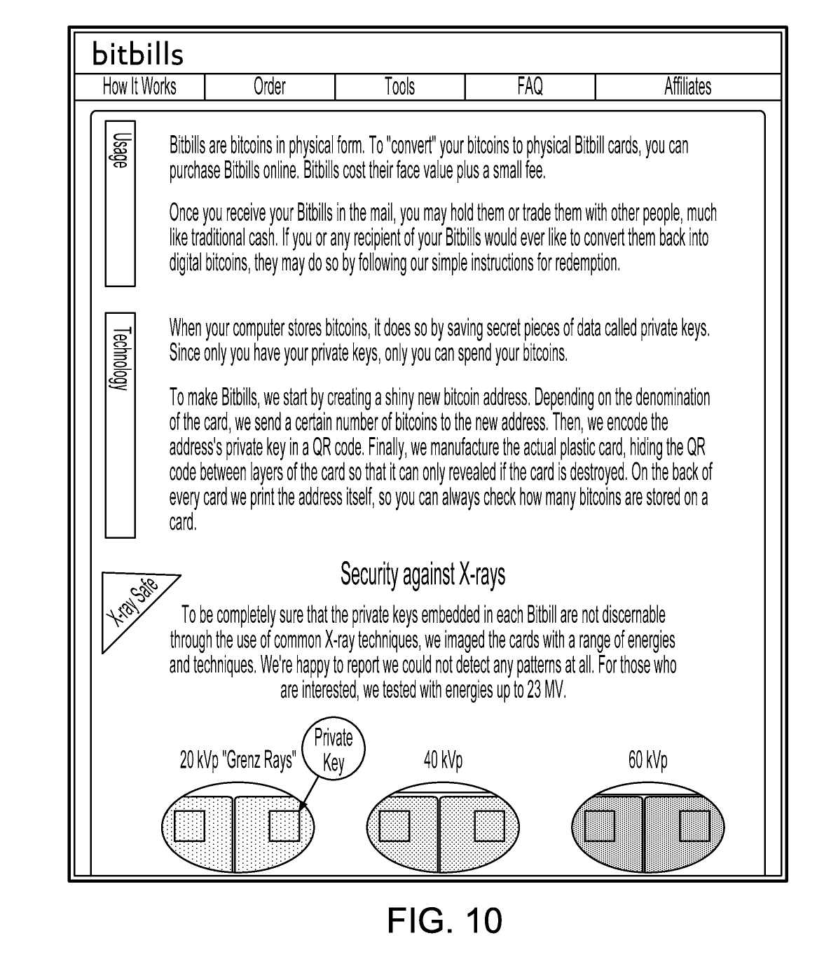

FIG. 10. Bitbills are Bitcoins in physical form. To “convert” your Bitcoins to physical Bitbill cards, you can purchase Bitbills online. Bitbills cost their face value plus a small fee. Once you receive your Bitbills in the mail you may hold them or trade them with other people, much like traditional cash. If you or any recipient of your Bitbills would ever like to convert them back into digital Bitcoins, they may do so by following our simple instructions for redemption. When your computer stores Bitcoins, it does so by saving secret pieces of data called private keys. Since only you have your private keys, only you can spend your Bitcoins. To make Bitbills, we start by creating a shiny new bit coin address. Depending on the denomination of the card, we send a certain number of Bitcoins to the new address. Then, we encode the address's private key in a QR code. Finally, we manufacture the actual plastic card, hiding the QR code between layers of the card so that it can be revealed if the card is destroyed. On the back of every card we print the address itself, so you can always check how many Bitcoins are stored on a card.

Security against x-rays. To be completely sure that the private keys embedded in each Bitbill are not discernible through the use of common x-ray techniques, we imaged the cards with a range of energies and techniques. We're happy to report we could not detect any patterns all. For those who are interested, we tested with energies up to 23 MV.

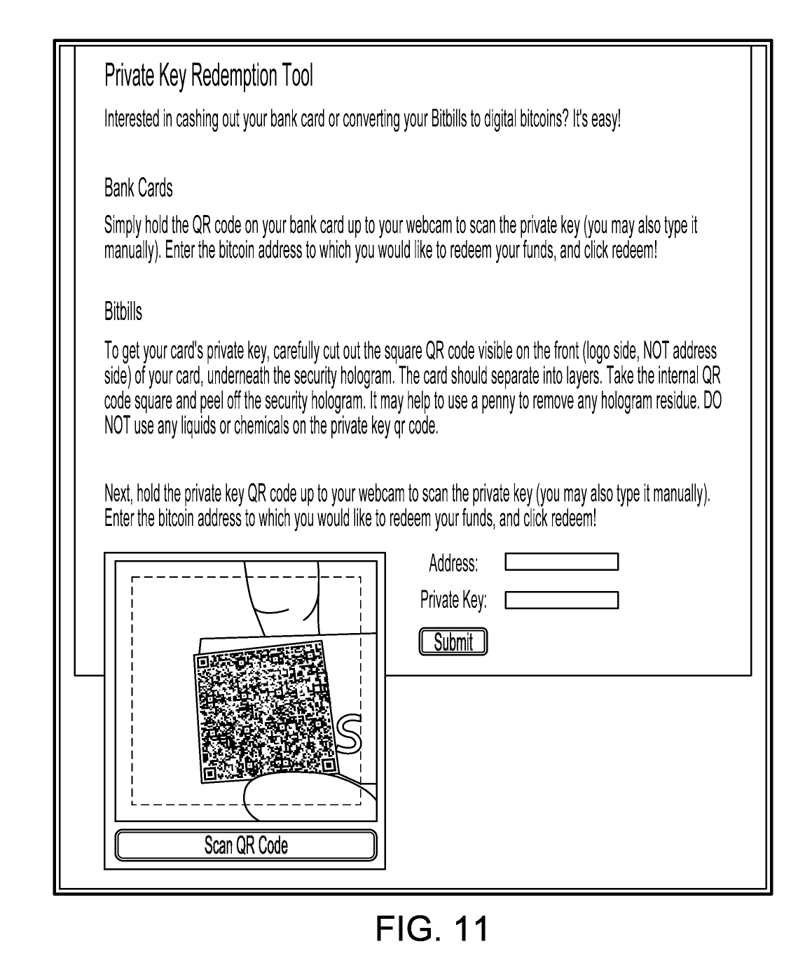

FIG. 11. Private key redemption tool. Interested in cashing out your bank card or converting your Bitbills to digital Bitcoins? It's easy! Bank cards: simply hold the QR code on your bank card up to your WebCam to scan the private key (you may also type it manually). Enter the Bitcoin address to which you would like to redeem your funds, and click redeem! Bitbills: to get your card's private key, carefully cut out the square QR code visible on the front (logo side, not address side) of your card, underneath the security hologram. The card should separate into layers. Take the internal QR code square and peel off the security hologram. It may help to use a penny to remove any hologram residue. Do not use any liquids or chemicals on the private key QR code. Next, hold the private key QR code up to your WebCam to scan the private key (you may also type it manually). Enter the bit coin address to which you would like to redeem your funds, and click redeem!

Various aspects of implementations of the system that we have described can be implemented on a wide variety of hardware, firmware, and software platforms, using a wide variety of network and online facilities. Implementations can be exposed to users through every possible kind of computer, machine, or interactive device, including mobile ones.

Other implementations are within the scope of the following claims.

1. An apparatus comprising
a physical device that carries value and can be physically delivered in a transaction, the physical device comprising
a representation of the value carried by the physical device, the representation being usable to transfer the value from the physical device to a digital domain, and
a security feature that can change from a state indicating that the value carried by the physical device has not been compromised to a state indicating that the value carried by the physical device may have been compromised, the change in state being detectable,
the representation of the value carried by the physical device being inaccessible except in a manner that causes the security feature to change state.

2. The apparatus of claim 1 in which the physical device comprises a portable device.

3. The apparatus of claim 1 in which the representation of the value is expressed in a human readable form.

4. The apparatus of claim 3 in which the human readable form comprises printed characters.

5. The apparatus of claim 1 in which the representation of value is expressed in a machine readable form.

6. The apparatus of claim 4 in which the machine readable form comprises a one-dimensional or two-dimensional bar or mark code.

7. The apparatus of claim 6 in which the code comprises a QR code.

8. The apparatus of claim 1 in which the representation of value comprises a secret.

9. The apparatus of claim 1 in which the representation of value comprises a private key of a public key and private key pair.

10. The apparatus of claim 9 in which the public key (a) can be provided by a paid party to a paying party in connection with a transaction and (b) can form the basis of an address a digital currency network to which the paying party can assign units of value for use by the paid party.

11. The apparatus of claim 1 in which the representation of value comprises fifty-one ASCII encoded characters representing a base 58 encoding of a private key part of a key pair associated with a Bitcoin-type network.

12. The apparatus of claim 8 in which the secrecy of the secret is preserved in the transaction.

13. The apparatus of claim 1 comprising an anti-counterfeiting feature.

14. The apparatus of claim 1 comprising an anti-counterfeiting hologram.

15. The apparatus of claim 1 comprising a visible and human readable representation of a public key associated with the representation of value.

16. The apparatus of claim 1 in which the representation of value is cryptographically protected.

17. The apparatus of claim 1 in which the digital domain comprises an online digital currency network.

18. The apparatus of claim 17 in which the digital currency network comprises Bitcoin™.

19. The apparatus of claim 1 in which the security feature comprises a visible element of the physical device.

20. The apparatus of claim 1 in which the security feature comprises an element that visually obscures the representation of value.

21. The apparatus of claim 1 in which the security feature comprises a packaging element of the physical device.

22. The apparatus of claim 1 in which the security feature comprises a holographic foil.

23. The apparatus of claim 1 in which the change of state indicating that the value has been compromised comprises a visible tampering.

24. A method comprising
producing a physical device that carries value and can be physically delivered in a transaction by
imparting to the physical device a representation of value that is usable to transfer the value from the physical device to a digital domain, and
imparting to the physical device a security feature that can change from a state indicating that the value carried by the physical device has not been compromised to a state indicating that the value carried by the physical device may have been compromised, the change in state being detectable,
the representation of the value imparted to the physical device being inaccessible except in a manner that causes the security feature to change state.

25. The method of claim 24 in which the representation of value imparted to the physical device comprises a secret acquired from a source.

26. The method of claim 24 comprising acquiring the representation of value as a secret from a source.

27. The method of claim 24 in which imparting the representation of value comprises encoding a secret and storing it on a physical medium.

28. The method of claim 27 in which imparting the representation of value comprises generating a private key and public key pair and using the private key as the basis for imparting the representation of value.

29. The method of claim 24 in which imparting the representation of value to the physical device comprises embedding an encoded version of the representation of value in the physical device.

30. A method comprising
as consideration in a transaction, delivering a physical device that comprises
a representation of value that can be transferred from the physical device to a digital domain, and
a security feature that can change from a state indicating that the value carried by the physical device has not been compromised to a state indicating that the value carried by the physical device may have been compromised, the change in state being detectable,
the representation of the value carried by the physical device being inaccessible except in a manner that causes the security feature to change state.

31. A method comprising
transferring value from a physical device to a digital domain, the
the physical device comprising
a representation of the value carried by the physical device, the representation being usable to transfer the value from the physical device to a digital domain, and
a security feature that can change from a state indicating that the value carried by the physical device has not been compromised to a state indicating that the value carried by the physical device may have been compromised, the change in state being detectable,
the representation of the value carried by the physical device being inaccessible except in a manner that causes the security feature to change state,
the transferring of value comprising
accessing the representation of value carried by the physical device, including causing the security feature to change state.

32. A method comprising
enabling a party to transfer value that is represented in a physical device that can be physically delivered in a transaction, directly to an online value exchange system on which the value can be represented electronically, without requiring the value to be passed through any intermediary party.

33. The method of claim 32 in which the value is represented in the physical device and on the online value exchange system using a common protocol for representing value.
